(19) United States
(12) Patent Application Publication
(10) Pub. No.: US 2010/0226006 A1
(43) Pub. Date: Sep. 9, 2010

(54) ACRYLIC CIRCULAR POLARIZATION 3D LENS AND METHOD OF PRODUCING SAME

(75) Inventor: Nicholas Bentley, Fleetwood, PA (US)

Correspondence Address: RATNERPRESTIA, P.O. BOX 980, VALLEY FORGE, PA, 19482, US

(73) Assignee: American Polarizers, Inc., Reading, PA (US)

(21) Appl. No.: 12/716,798

(22) Filed: Mar. 3, 2010

Related U.S. Application Data
(60) Provisional application No. 61/157,417, filed on Mar. 4, 2009.

(51) Int. Cl. G02B 27/26; B29D 11/00; B32B 38/00

(52) U.S. Cl. 359/465; 264/1.32; 156/306.6; 156/272.6; 156/250

(57) ABSTRACT

A 3D circular polarization apparatus comprises first and second acrylic layers, a quarter wave layer positioned between the first and second acrylic layers, and a linear polarizer layer adjacent to the quarter wave layer and positioned between the first and second acrylic layers. The 3D polarization apparatus may be produced by adhering a first acrylic layer to a first surface of a quarter wave layer, adhering a second surface of the quarter wave layer to a first surface of a linear polarizer layer, and adhering a second surface of the linear polarizer layer to a second acrylic layer to form the 3D polarization apparatus.

### FIELD OF THE INVENTION

This invention relates to circular polarization lenses for use in 3-dimensional applications.

### BACKGROUND OF THE INVENTION

There has been a renewed interest in 3D (3-dimensional) technology, due to the increasing popularity of 3D media. 3D applications include films, television shows, amusement park shows and rides, and so forth. Other applications may also include camera and sensor technologies.

Traditional 3D technology used two colored lenses, for instance, a red lens and a blue lens to perceive a 3D image. For glasses with a red/blue configuration, a 3D viewable image, for instance, projected on a screen, is composed of two slightly offset images (dichromatic): one in red and one in blue. The red lens blocks some of the blue image and the blue lens blocks some of the red image. Hence, the red lens causes the red image to appear brighter, and the blue image causes the blue image to appear brighter. This image isolation enables viewers to see a 3D effect.

Linear polarization lenses have also been used to perceive a 3D viewable image. Using linear polarization, the 3D viewable image is composed of two polarized images that are linearly polarized at 90° relative to one another. The viewing glasses may then use lenses which are linearly polarized at 90° relative to one another such that each eye only receives the image matching the polarization of the projected image and blocks the other one. Again, the result of isolating the images allows the viewer to see a 3D effect. Linear polarization lenses have limitations including loss of effect (e.g., if the viewer is not looking through the sweet-spots), diminished clarity, and an unrealistic 3D effect.

Due to the problems associated with dichromatic and linear polarization lenses, circular polarization lenses have been pursued for providing an improved and more life-like 3D experience.

### SUMMARY OF THE INVENTION

According to an embodiment of the present invention, a 3D circular polarization apparatus comprises first and second acrylic layers, a quarter wave layer positioned between the first and second acrylic layers, and a linear polarizer layer adjacent to the quarter wave layer and positioned between the first and second acrylic layers.

According to another embodiment of the present invention, a method for producing the 3D polarization apparatus includes adhering a first acrylic layer to a first surface of a quarter wave layer, adhering a second surface of the quarter wave layer to a first surface of a linear polarizer layer, and adhering a second surface of the linear polarizer layer to a second acrylic layer to form the 3D polarization apparatus.

### BRIEF DESCRIPTION OF THE DRAWINGS

The invention may be understood from the following detailed description when read in connection with the accompanying figures:

FIG. 1 is a schematic perspective view of a known circularly polarized light generator;

FIG. 2 is a schematic side view of the layers which make up a 3D circular polarization apparatus according to an embodiment of the present invention;

FIG. 3 is an exploded-schematic side view of the layers which make up the 3D circular polarization apparatus of the embodiment of the present invention shown in FIG. 2; and

FIG. 4 is an exemplary method of producing a 3D circular polarization apparatus according to an embodiment of the invention.

### DETAILED DESCRIPTION OF THE INVENTION

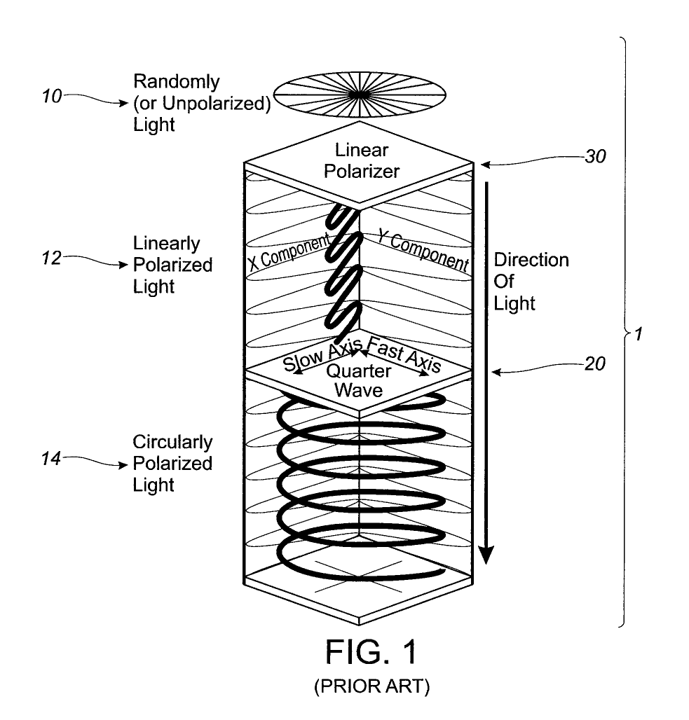

Unpolarized, randomly polarized, incoherent or mixed-polarized light may be formed into linearly, circularly, or elliptically polarized light. As unpolarized light passes through a linear polarizer layer, the linear polarizer layer only allows the light that is polarized parallel to the transmission axis to pass through; otherwise, the linear polarizer layer absorbs the randomly polarized light. FIG. 1 depicts a circularly polarized light generator 1. In generator 1, randomly polarized light 10 passes through linear polarizer layer 30 to form linearly polarized light 12. A linear polarizer layer may have a horizontal or vertical polarization axis. The polarization direction is perpendicular to the polarization axis.

Linearly polarized light may be converted into circularly polarized light by using a quarter wave layer (or wave retarder or quarter wave plate). As is generally known in the art, a quarter wave retarder is known to have a fast axis (extraordinary) and a slow axis (ordinary). The light passing through the fast axis travels more quickly through the wave retarder than through the slow axis. The quarter wave layer retards the velocity of one of the polarization components (x or y) one quarter of a wave out of phase from the other polarization component. This causes the light to become circularly polarized. Again referring to FIG. 1, linearly polarized light 12 passes through quarter wave layer 20 to form circularly polarized light 14. Some refer to the action of the quarter wave as “twisting” the polarized light. Depending on which polarization component is retarded, one will have either a left handed or a right handed circular polarizer. Thus, the position of the polarization axis of the linear polarizer layer relative to the position of the fast axis of the quarter wave layer results in a left or a right handed circular polarization.

Similar to a dichromatic or linear polarizing set-up, a 3D viewable image may be created by projecting a first image having left handed circular polarization and a second image having right handed circular polarization. A 3D image may then be perceived through the use of glasses having one lens configured to pass left handed circular polarized light (blocking right handed polarized light) and another lens configured to pass right handed circular polarized light (blocking left handed polarized light). Thus, each eye only receives the image matching the circular polarization of the projected image and blocks the other one. Lenses configured to pass circular polarized light may be created by reversing the position of the linear polarizer layer and the quarter wave layer along the direction of light in FIG. 1. Left and right handedness can be achieved through the positioning of the polarization axis of the linear polarizer layer relative to the fast axis of the quarter wave layer.

Aspects of the present invention include a 3D circular polarization apparatus and a method for making the same. In an embodiment of the present invention, a 3D circular polarization apparatus comprises first and second acrylic layers, a quarter wave layer positioned between the first and second acrylic layers, and a linear polarizer layer adjacent to the quarter wave layer and positioned between the first and second acrylic layers.

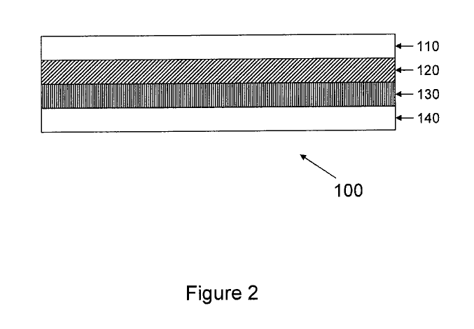

FIG. 2 depicts a 3D circular polarization apparatus 100. The illustrated apparatus includes a first acrylic layer 110, a quarter wave layer 120, a linear polarizer layer 130, and a second acrylic layer 140. Referring to FIG. 1, light traveling in the indicated direction through the linear polarizer layer 30 and the quarter wave layer 20 produces circular polarized light along an “optical path.” For the embodiment shown in FIG. 2, to view circular polarized light entering the first acrylic layer 110, a viewer (e.g., eyeballs) would be positioned in front of the second acrylic layer 140 looking through the 3D circular polarization apparatus 100. An optical path would include light entering the first acrylic layer 110 and passing through the first acrylic layer 110, the quarter wave layer 120, the linear polarizer layer 130, and the second acrylic layer 140. This arrangement will pass circular polarized light (e.g., from generator 1) matching the circular polarization of the apparatus and will block light that is not polarized as such. As will be readily understood to one of ordinary skill in the art, it is desired to maintain a clear or substantially clear optical path to achieve optimal viewing results.

Birefringence, or double refraction, is the decomposition of a ray of light into two rays (the ordinary ray and the extraordinary ray) when it passes through certain types of material. The quarter wave layer is a birefringent material, which retards the velocity of one of the polarization components (x or y) one quarter of a wave out of phase from the other polarization component, producing the desired effect. Other birefringent (or slightly birefringent) materials, however, should be minimized in the apparatus to reduce distortion of the image and loss of the 3D effect. Birefringence of the other materials in 3D lenses has been an on-going problem in developing clear and effective 3D lenses.

The first acrylic layer 110 and the second acrylic layer 140 may be the same or a different type of acrylic. Any suitable acrylic may be used, which includes thermoplastic and transparent plastics. In an embodiment of the present invention, the acrylic is polymethylmethacrylate (PMMA). At least one of the first and second acrylic layers may be a PMMA layer. In a preferred embodiment, both of the first and second acrylic layers are PMMA layers. Each PMMA layer may be a cell cast polymethylmethacrylate. For a lens application, cell cast PMMA has been found to be generally more desirable than an extruded PMMA because extruded PMMA has been found to have more visible defects (e.g., birefringence), which can obscure and distort the image when the 3D circular polarization apparatus is in use.

The acrylic layers 110 and 140, at least in part, help to protect the quarter wave layer 120 and the linear polarizer layer 130 in its final form, e.g., in use as lenses in a pair of glasses. The first and second acrylic layers may be the same or different thicknesses. In one embodiment, the acrylic layers each have a thickness of at least about 15 mils or greater. In a preferred embodiment, each of the acrylic layers are about 20 mils in thickness. Acrylic layers of this thickness help protect the inner layers and produce sturdy lenses. The acrylic layers should not be too thick, however, as to make the lenses heavy and uncomfortable and/or to obscure the optical path. As will be evident to one or ordinary skill in the art, thicker materials may be more likely to introduce birefringence, particularly based on the viewers' relative position to the lens.

As used herein, “mil” or “mils” are generally understood to be a thousandths of an inch. Thus, if a thickness is defined as 20 mils, it would equate to 20 thousandths of an inch (0.020 inches) or could be converted to about 0.508 millimeters.

The quarter wave layer 120 (or quarter wave plate) may comprise a quarter wave retarder film. The quarter wave retarder film may be made from any suitable material known in the art. In an embodiment of the present invention, the quarter wave retarder film is an acetate. Acetate may include, for example, cellulose acetate, cellulose diacetate, and cellulose triacetate. In one embodiment, the quarter waver retarder film is cellulose diacetate. The quarter wave layer is a clear, birefringent material, such that any linearly polarized light which strikes the layer will be divided into two components with different indices of refraction. The quarter wave layer creates a quarter-wavelength phase shift and can change linearly polarized light to circular and vice versa. The quarter wave layer may be defined by its wave retardance. For example, quarter wave retarders may be centered on the visible region, e.g., 550 nm. In an embodiment of the present invention, the quarter wave layer may be centered at 135-140 nm +/−5 nm. The type of quarter wave layer of the 3D circular polarization apparatus is determined and designed, however, relative to the wave retardance of the filter from the image source, e.g., the filter on the projectors. In other words, the wave retardance on the 3D circular polarization apparatus should be matched to the wave retardance from the source of the image.

The linear polarizer layer 130 may be made from any suitable material known in the art. Common materials include, for example, cellulose triacetate (CTA), cellulose acetobutyrate (CAB), and polyvinyl alcohol (PVA) sheets. In a preferred embodiment, the linear polarizer is a triacetate sheet. As discussed above, the linear polarizer allows light to pass through the material in one direction of polarization and absorbs light in the other.

When the first acrylic layer 110, the quarter wave layer 120, the linear polarizer layer 130, and the second acrylic layer 140 are positioned together, the resulting composite structure may form a lens or lenses. As discussed above, based on the position of the polarization axis of the linear polarizer relative to the position of the fast axis of the wave retarder, a left or right handed circular polarization results. Thus, both left and right handed circular polarization lenses may be formed. Furthermore, a frame may be configured to receive the lenses. In particular, suitable frames may be made from any material, but often comprise plastic frames to house and protect the lenses. The frames should be designed to fit securely on the viewer and to be comfortable and suitable for 3D viewing. In particular, the frames should optimize the optical path for the viewer. Furthermore, appropriate frames should be selected so as to snuggly hold the lenses in the frames, but so as to not introduce stress and resulting birefringence along the edges of the lenses.

According to another embodiment of the present invention, a method for producing the 3D polarization apparatus includes adhering a first acrylic layer to a first surface of a quarter wave layer, adhering a second surface of the quarter wave layer to a first surface of a linear polarizer layer, and adhering a second surface of the linear polarizer layer to a second acrylic layer to form the 3D polarization apparatus.

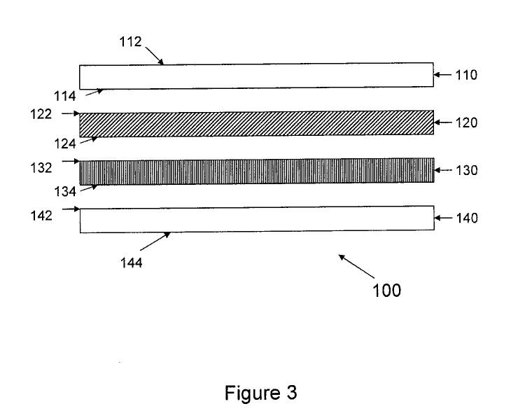

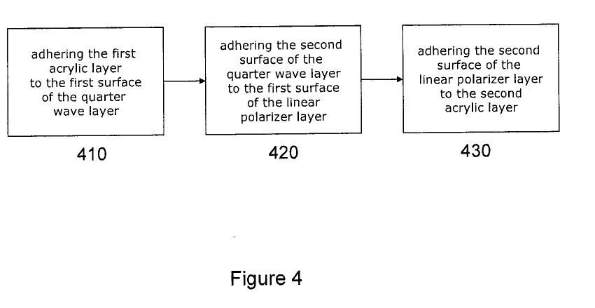

Referring to FIG. 3, the first acrylic layer 110 has a first surface 112 and a second surface 114, the quarter wave layer 120 has a first surface 122 and a second surface 124, the linear polarizer layer 130 has a first surface 132 and a second surface 134, and the second acrylic layer 140 has a first surface 142 and a second surface 144. Referring to FIG. 4, the 3D polarization apparatus 100 may be produced by the following steps: (1) step 410—adhering the first acrylic layer 110 to the first surface 122 of the quarter wave layer 120; (2) step 420—adhering the second surface 124 of the quarter wave layer 120 to the first surface 132 of the linear polarizer layer 130; and (3) step 430—adhering the second surface 134 of the linear polarizer layer 130 to the second acrylic layer 140.

The first acrylic layer 110, the quarter wave layer 120, the linear polarizer layer 130, and the second acrylic layer 140 may be positioned together using any suitable method. In one embodiment, sheets of each of the first acrylic layer 110, the quarter wave layer 120, the linear polarizer layer 130, and the second acrylic layer 140 are positioned together and held in position via tape along one edge.

Prior to adhering the first acrylic layer 110, the quarter wave layer 120, the linear polarizer layer 130, and the second acrylic layer 140, the layers may be cleaned. Without wishing to be bound to a particular theory, it is believed that cleaning the layers may remove any contaminants, which may adversely impact effective bonding. At least one surface of at least one of the first acrylic layer, the quarter wave layer, the linear polarizer layer, and the second acrylic layer should be cleaned. In a preferred embodiment, each surface should be cleaned even if it will not be ultimately bonded to another layer, i.e., cleaning both the first surface 112 and the second surface 114 of the first acrylic layer 110, etc.

In an embodiment of the present invention, at least one surface of a layer may be cleaned with an organic solvent, such as alcohol. In a preferred embodiment, the alcohol is isopropyl alcohol, or more preferably, ACS isopropyl alcohol. ACS isopropyl alcohol is designated as American Chemical Society (ACS) reagent grade because it meets the specifications of the ACS for reagent chemicals. Without wishing to be bound to a particular theory, it is believed that cleaning the layers with an alcohol often lead to delamination problems. In particular, lower grade alcohols are believed to cause problems such as contamination and haziness issues. Thus, the ACS isopropyl alcohol, which is a chemical grade of highest purity, minimizes contaminants to the surfaces of the materials. At least one surface of a layer may be cleaned by any means suitable. In an embodiment of the present invention, the ACS isopropyl alcohol is applied by wiping the alcohol on the surface with a cloth.

Prior to the adhering steps, the layers may undergo a corona treatment. High frequency corona surface treatments (or air plasma) is generally known in the art as a surface treatment process that may improve the bonding characteristics of different materials by raising the surface energy of the material. In an embodiment of the present invention, at least one surface of at least one of the first acrylic layer 110, the quarter wave layer 120, the linear polarizer layer 130, and the second acrylic layer 140 is corona treated. In a preferred embodiment, each surface is corona treated even if it will not be ultimately bonded to another layer, i.e., corona treating both the first surface 112 and the second surface 114 of the first acrylic layer 110, etc. Furthermore, corona treating of each surface may occur more than once, i.e., the second surface 114 of the first acrylic layer 110 may undergo two passes of corona treatment. Without wishing to be bound to a particular theory, it is believed that the corona treatment may remove some of the plasticizer, e.g., from a triacetate sheet, and may improve the bonding strength between the surfaces of the layers. Subsequent to the corona treatment, the surfaces may be passed under air to remove any remaining particulates. In particular, the surfaces may be, for example, blown with ionized air.

The adhering steps may occur by using any suitable bonding methods known in the art. In an embodiment of the present invention, the second surface 114 of the first acrylic layer 110 is adhered to the first surface 122 of the quarter wave layer 120 by applying an adhesive. Similarly, the second surface 124 of the quarter wave layer 120 is adhered to the first surface 132 of the linear polarizer layer 130 by applying an adhesive. Lastly, the second surface 134 of the linear polarizer layer 130 is adhered to the first surface 142 of the second acrylic layer 140 by applying an adhesive. The adhesive may be applied to each layer in any order or the adhesive may be applied to all layers simultaneously. The adhesive may be applied in any configuration, e.g., stripes, dots, an s-shape, a u-shape, etc., between the layers in an amount and manner sufficient to result in adequate bonding (e.g., to avoid or minimize delamination).

As used herein, delamination is used as is generally known in the art to mean a mode of failure for composite materials. In particular, delamination may result due to inadequate bonding or loss of bonding between the layers resulting in failure of the 3D circular polarization apparatus. Delamination may occur due to a number of factors, including but not limited to, an attempted bond between unsuitable materials, insufficient adhesive, contamination, stresses on the composite, etc.

In a preferred embodiment, if the layers are positioned together using a taped edge, the adhesive may be applied along three edges, e.g., the taped edge and two sides. Any suitable adhesive known in the art to bond the material disclosed herein may be used. In an embodiment of the present invention, a two-part urethane adhesive may be used. Two-part urethane adhesives are typically packaged in two containers including, for example, a polyol, such as a polyester polyol, and an isocyanate, such as 1,6-hexamethylene diisocyanate (HDI) or a homopolymer thereof. When the two parts are mixed together a chemical reaction occurs to form a crosslinked adhesive. Two-part urethane adhesives may be applied at room temperature and do not need heat or moisture to cure. Other adhesives may be used and cure under known conditions, i.e., standard atmosphere, heating, ultraviolet light, etc. Curing times will vary depending on the type and amount of adhesive used. For the two-part urethane adhesive, curing times may take upwards of 24 hours to effectively cure.

The process for forming the 3D circular polarization apparatus 100 may further comprise laminating the first acrylic layer 110, the quarter wave layer 120, the linear polarizer layer 130, and the second acrylic layer 140 by applying adhesive and then applying pressure uniformly across the layers. Laminating is a technique generally known in the art to unite multiple layers of material together. The layers may be joined together with heat and/or pressure. In a preferred embodiment, once adhesive has been applied between the first acrylic layer 110, the quarter wave layer 120, the linear polarizer layer 130, and the second acrylic layer 140, the composite material is compressed using a roll laminator. Roll laminators subject uniform pressure across the width direction of the machine. In one embodiment, the taped edge is fed into the roll laminator first. Thus, as the composite material is fed through the roll laminator, the pressure is continuously applied uniformly across the composite material as the material travels in the machine direction. By using such a technique, it is believed that the adhesive is more evenly distributed throughout the layers and any air trapped between the layers is minimized or eliminated by the pressure. Although, any technique which is generally known in the art may be utilized to unite the layers together uniformly.

Once the first acrylic layer 110, the quarter wave layer 120, the linear polarizer layer 130, and the second acrylic layer 140 are adhered together, a protective film or covering may be applied to the first surface 112 of the first acrylic layer 110 and/or the second surface 144 of the second acrylic layer 140 to protect the 3D circular polarization apparatus 100 during subsequent processing, handling, storage, etc. The protective film may include any materials generally known in the art, for example, a paper layer. As will be understood to one of ordinary skill in the art, this paper layer is subsequently removed to allow for use of the 3D circular polarization apparatus 100.

The process of making the 3D circular polarization apparatus 100 may further comprise cutting the 3D polarization apparatus into a lens shape. The lens shape may be cut using appropriate cutting tools known in the art. In a preferred embodiment, a laser cutter is used to cut out the lens shapes. The shape of the lenses may be any shape suitable to fit over or into frames typical for eyewear or glasses. The lens shapes may then be further heat formed into a finished lens. Heat forming may include heating the lens shape in a mold to form the lens shapes into finished lenses. Heat forming may occur under conditions, temperatures, and for a duration suitable to form a finished lens. In particular, heat forming may occur in the temperature range of about 100-120° C. In a preferred embodiment, the lenses are heat formed at about 110° C. for about 4 minutes. Although, any suitable techniques may be used to produce the lens shapes and finished lenses.

The finished lenses may then be positioned into a frame to form the 3D polarization apparatus. In particular, suitable frames may be made from any material, but often comprise paper or plastic frames to house the lenses. Plastic frames are more sturdy and protect the lenses and are often more comfortable and suitable for 3D viewing. Appropriate frames should be selected so as to snuggly hold the lenses, but should not introduce stress along the edges resulting undesired birefringence or potential delamination. Thus, the resulting eyewear will provide a left handed circular polarization lens, for example, positioned in front of the left eye, and a right handed polarization lens, for example, positioned in front of the right eye. As discussed above, the position of the linear polarizer layer having a polarization axis relative to the quarter wave retarder film having a fast axis results in the left or right handed circular polarization.

Some or all of the above process steps may occur within a clean room, e.g., a class 100 environment or better. It is preferred that at least the corona treating steps, adhesive applying steps, and laminating steps occur within a clean room environment to minimize contamination in between the layers.

In a preferred embodiment of the present invention, the process steps may occur in the following sequence: (1) positioning together the first acrylic layer 110, the quarter wave layer 120, the linear polarizer layer 130, and the second acrylic layer 140; (2) taping an edge of the first acrylic layer 110, the quarter wave layer 120, the linear polarizer layer 130, and the second acrylic layer 140 together; (3) cleaning at least one surface of at least one of the first acrylic layer 110, the quarter wave layer 120, the linear polarizer layer 130, and the second acrylic layer 140; (4) corona treating at least one surface of at least one of the first acrylic layer 110, the quarter wave layer 120, the linear polarizer layer 130, and the second acrylic layer 140; (5) blowing ionized air on each surface of the first acrylic layer 110, the quarter wave layer 120, the linear polarizer layer 130, and the second acrylic layer 140; (6) adhering a first acrylic layer 110 to a first surface 122 of a quarter wave layer 120; adhering a second surface 124 of the quarter wave layer 120 to a first surface 132 of a linear polarizer layer 130; and adhering a second surface 134 of the linear polarizer layer 130 to a second acrylic layer 140; (7) laminating the first acrylic layer 110, the quarter wave layer 120, the linear polarizer layer 130, and the second acrylic layer 140 by applying pressure uniformly on the layers subsequent to applying the adhesive; (8) allowing sufficient time and conditions for curing of the adhesive; (9) applying a protective film to one or both of the first acrylic layer 110 and the second acrylic layer 140; (10) cutting the 3D polarization apparatus 100 into lens shapes; (11) forming the lens shapes into lenses by heating and molding the lenses; and (12) inserting the lenses into a frame suitable to wear for viewing 3D images. The resulting 3D circular polarization apparatus 100 may be used as lenses within glasses for a 3D viewing experience.

The 3D circular polarization apparatus of the present invention has been found to have minimized birefringence and enhanced clarity over circular polarization lenses of the prior art. Surprisingly, the “sweet-spot” of the present invention for viewing the image is much larger through the lenses, i.e., the viewer does not need to look through the exact center of the lenses for a quality effect. Thus, the materials and configuration of the above described invention has produced a better quality, more life-like, realistic 3D experience.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A 3D circular polarization apparatus comprising:
first and second acrylic layers;
a quarter wave layer positioned between the first and second acrylic layers; and
a linear polarizer layer adjacent to the quarter wave layer and positioned between the first and second acrylic layers.

2. An apparatus according to claim 1, wherein the quarter wave layer comprises a quarter wave retarder film.

3. An apparatus according to claim 2, wherein the quarter wave retarder film is cellulose diacetate.

4. An apparatus according to claim 2, wherein the position of the linear polarizer layer having a polarization axis relative to the quarter wave retarder film having a fast axis results in a left or right handed circular polarization.

5. An apparatus according to claim 1, wherein at least one of the first and second acrylic layers is a polymethylmethacrylate layer.

6. An apparatus according to claim 5, wherein the polymethylmethacrylate layer is a cell cast polymethylmethacrylate.

7. An apparatus according to claim 1, wherein at least one of the first and second acrylic layers has a thickness of about 15 mils or greater.

8. An apparatus according to claim 1, wherein the linear polarizer layer is a triacetate sheet.

9. An apparatus according to claim 1, wherein the first acrylic layer, the quarter wave layer, the linear polarizer layer, and the second acrylic layer form lenses.

10. An apparatus according to claim 9, further comprising:
a frame configured to receive the lenses.

11. A process for producing a 3D polarization apparatus comprising:
(a) adhering a first acrylic layer to a first surface of a quarter wave layer;
(b) adhering a second surface of the quarter wave layer to a first surface of a linear polarizer layer; and
(c) adhering a second surface of the linear polarizer layer to a second acrylic layer to form the 3D polarization apparatus.

12. The process according to claim 11, wherein the quarter wave layer is a quarter wave retarder film.

13. The process according to claim 12, wherein the quarter wave retarder film is cellulose diacetate.

14. The process according to claim 12, wherein the position of the linear polarizer layer having a polarization axis relative to the quarter wave retarder film having a fast axis results in a left or right handed circular polarization.

15. The process according to claim 11 further comprising, prior to the adhering steps, cleaning at least one surface of at least one of the first acrylic layer, the quarter wave layer, the linear polarizer layer, and the second acrylic layer with an alcohol.

16. The process according to claim 15, wherein the alcohol is isopropyl alcohol.

17. The process according to claim 15, wherein the alcohol is ACS isopropyl alcohol.

18. The process according to claim 11 further comprising, prior to the adhering steps, corona treating at least one surface of at least one of the first acrylic layer, the quarter wave layer, the linear polarizer layer, and the second acrylic layer.

19. The process according to claim 11 further comprising laminating the first acrylic layer, the quarter wave layer, the linear polarizer layer, and the second acrylic layer by applying adhesive and applying pressure uniformly.

20. The process according to claim 19, wherein the uniform pressure is applied using a roll laminator.

21. The process according to claim 11 further comprising cutting the 3D polarization apparatus into a lens shape.

22. The process according to claim 21, further comprising heat forming the lens shape into a lens.

23. The process according to claim 22, wherein the heat forming step comprises heating the lens shape at about 110° C. for about 4 minutes.

24. The process according to claim 22, further comprising positioning the lens into a frame to form the 3D polarization apparatus.

25. The process according to claim 11, wherein at least one of the first and second acrylic layers is a polymethylmethacrylate layer.

26. The process according to claim 11, wherein at least one of the first and second acrylic layers has a thickness of about 15 mils or greater.

27. The process according to claim 11, wherein the linear polarizer layer is a triacetate sheet.
